(19) United States
(12) Patent Application Publication
(10) Pub. No.: US 2010/0046550 A1
(43) Pub. Date: Feb. 25, 2010

(54) CONTEXT BASED HEADER SELECTION IN A MULTI-FLOW PACKET APPLICATION

(75) Inventors: Gigy S. Mammarappallil, Arlington Heights, IL (US); George Cherian, San Diego, CA (US)

Correspondence Address: Cuenot, Forsythe & Kim, 12230 FOREST HILL BLVD., SUITE 120, WELLINGTON, FL, 33414, US

(73) Assignee: MOTOROLA, INC., Schaumburg, IL (US)

(21) Appl. No.: 12/197,992

(22) Filed: Aug. 25, 2008

(51) Int. Cl. H04J 3/24

(52) U.S. Cl. 370/474

(57) ABSTRACT

A method (300) of supporting communication between a Multi-flow Packet Application (MFPA) based access network (102) and an access terminal (104, 106, 108). The method can include, from at least two types of data flows supported on the MFPA based access network, detecting a type of data flow to be used to communicate with the access terminal. The method also can include dynamically selecting a type of packet header (124, 128) for communicating with the access terminal based on the detected type of data flow, and generating at least one packet (126) using the selected type of packet header. Further, the packet can be communicated to the access terminal using the detected type of data flow.

### BACKGROUND OF THE INVENTION

1. Field of the Invention

The present invention generally relates to wireless communications and, more particularly, to wireless communication application layer protocols.

2. Background of the Invention

The use of radio access technologies continues to proliferate throughout the industrialized world. In addition to wireless telecommunications, which have been widely available since the latter part of the twentieth century, a variety of other wireless communication technologies are now or soon will be available to consumers. For example, consumers now can wirelessly communicate over a variety of radio access networks to send text messages, access the Internet and download media content. In the near future, wireless video conferencing and other forms of high data rate wireless communication services also will be available to consumers over radio access networks.

A number of different air interface standards are being developed to address expanding consumer demand for these wireless communication services. For example, the Third Generation Partnership Project (3GPP) Long Term Evolution (LTE) air interface standard is being developed to improve upon the third-generation (3G) Universal Mobile Telecommunications System (UMTS) mobile telephone standard in order to cope with future technology evolutions. Another air interface standard that is currently under development is the High Rate Packet Data (HRPD) air interface standard, which is a packet data protocol being developed for 3GPP2 based on Code Division Multiple Access (CDMA) 2000. Still, other air interface standards expected to be widely deployed are also under development.

Each air interface standard typically defines various protocol layers. For instance, the HRPD air interface standard defines an application layer, a stream layer, a session layer, a connection layer, a security layer, a media access control (MAC) layer and a physical layer. Within each protocol layer, one or more layer specific protocols may be required, some of which may be defined within a more encompassing specification. In the HRPD application layer, for example, a Multi-flow Packet Application (MFPA) protocol is being defined to provide a mechanism to define multiple application data flows which can be assigned priorities and associated with QoS profiles. Within the MFPA protocol, additional protocols are to be provided to control various application layer processes. These additional protocols presently include a Flow Control protocol, a Data Over Signaling protocol, a Radio Link protocol and a Location Update Protocol. Nonetheless, HRPD is an evolving standard and protocols may be added or removed as may be required.

Differences among the various air interface standards tend to complicate the inter-operation of access networks which are based on different standards. For example, the MFPA protocol requires use of the point-to-point (PPP) protocol, which provides a direct connection between an access terminal (e.g. a mobile device) and the access network. To perform an inter-access network handoff of a communication session to a MFPA/HRPD based access network from another type of access network (e.g. a LTE based access network), significant network resources would be required to establish the direct connection to the MFPA/HRPD access network.

### SUMMARY OF THE INVENTION

One embodiment of the present invention relates to a method of supporting communication between a Multi-flow Packet Application (MFPA) based access network and an access terminal. The method can include, from at least two types of data flows supported on the MFPA based access network, detecting a type of data flow to be used to communicate with the access terminal. The method also can include dynamically selecting a type of packet header for communicating with the access terminal based on the detected type of data flow, and generating at least one packet using the selected type of packet header. Further, the packet can be communicated to the access terminal using the detected type of data flow.

Another embodiment of the present invention relates to a Multi-flow Packet Application (MFPA) based access network. The MFPA can include a controller that, from at least two types of data flows supported on the MFPA based access network, detects a type of data flow to be used to communicate with an access terminal. The controller also can dynamically select a type of packet header for communicating with the access terminal based on the detected type of data flow, and generate at least one packet using the selected type of packet header. Further, the controller can communicate the packet to the access terminal using the detected type of data flow.

Yet another embodiment of the present invention can include a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts field definitions for fields of a radio link protocol (RLP) header that are useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to facilitating inter-access network (access network) handoff of a communication session to an access network that is implemented in accordance with the High Rate Packet Data (HRPD) air interface standard and the Multi-flow Packet Application (MFPA) protocol. More particularly, the example arrangements that will be described introduce the concept context based header selection for multi-flow packet applications. For example, a required data flow type can be identified for an access terminal seeking to establish network presence on a MFPA based access network and, based on the required data flow type, a suitable type of packet header can be selected which enables an inter-access network handoff of the access terminal to the MFPA based access network, regardless of whether the access terminal is configured to communicate using a point-to-point protocol (PPP).

For example, if the access terminal is configured to communicate octet-based data, the packet header that is selected can be an octet-based header that includes PPP attributes and supports octet-based data flow. If, however, the access terminal is configured for packet-based communications without the use of PPP, the packet header that is selected can be a header (hereinafter “packet-based header”) that supports packet-based data flow. For instance, the packet-based header can indicate packet boundaries and eliminate the requirement that PPP be used for communications between the MFPA based access network and the access terminal.

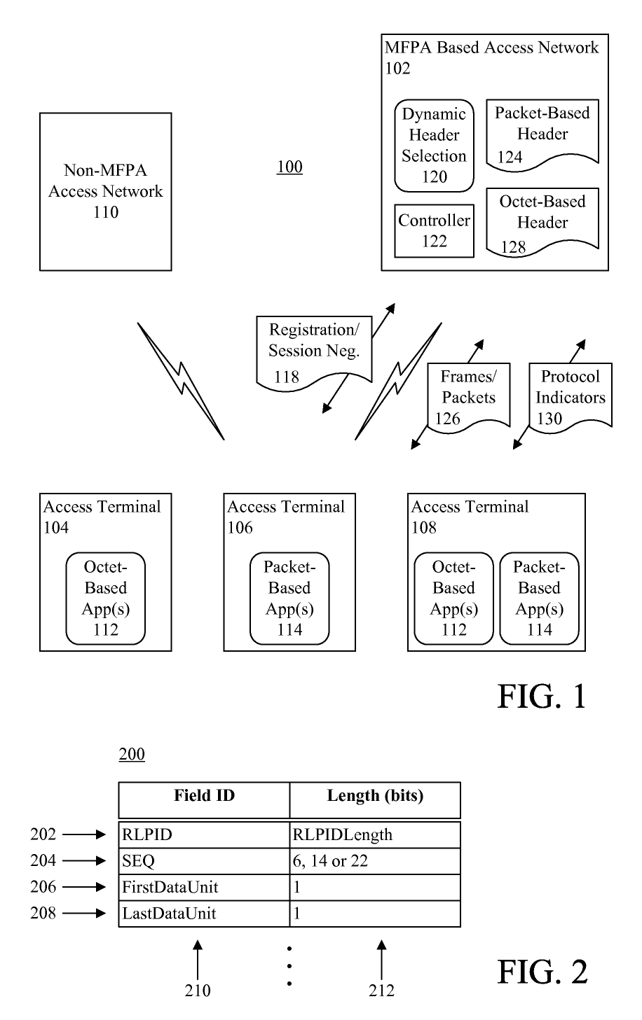

FIG. 1 depicts a communication system 100 that is useful for understanding the present invention. The communication system 100 can include a MFPA based access network 102. The access network 102 can be any access network which implements the High Rate Packet Data (HRPD) air interface standard and the MFPA protocol. In that regard, the access network 102 can be configured to communicate with access terminals, such as access terminal 104, 106, 108, in accordance with the third-generation (3G) cellular data technology Evolution Data Optimized (1xEV-DO) communications standard (also known as TIA/EIA/IS-856), which may be based on the Code Division Multiple Access (CDMA) 2000 standard. As such, the access network 102 can include suitable access points (e.g. base transceiver stations), base station controllers, any of a variety of suitable network servers, and/or the like.

The communication system also can include a non-MFPA based access network 110. Examples of such an access network can include, but are not limited to, Long Term Evolution (LTE) based access networks. The access network 110 also can include suitable access points (e.g. base transceiver stations), base station controllers, any of a variety of suitable network servers, and/or the like.

The access terminals 104, 106, 108 can be any wireless communication devices configured to communicate with the access network 102. Examples of such access terminals can include, but are not limited to, mobile telephones, mobile radios, personal digital assistants, computers (e.g. mobile computers or other wirelessly linked computers), set-top boxes, network appliances, and so on.

In one arrangement, the access terminals 104, 106, 108 each can include one or more communication applications 112, 114 that dynamically configure the access terminals 104, 106, 108 for access network communications and inter-access network handoffs. For example, the access terminal 104 can include an octet-based communication application 112, the access terminal 106 can include a packet-based communication application 114, and the access terminal 108 can include both octet-based communication application 112 and a packet-based communication application 114. Accordingly, the access terminal 104 can communicate with the access network 102 using octet-based data flows, the access terminal 106 can communicate with the access network 102 using packet-based data flows, and the access terminal 108 can communicate with the access network 102 using either octet-based data flows or packet based data flows.

When an inter-access network handoff to the access network 102 is to be performed, for example if the access terminal 106 is to handoff from the access network 110 to the access network 102, registration/session negotiation messages 118 can be communicated between the access terminal 106 and the access network 102. For example, the access terminal 106 can detect communication signals that are broadcast by the access network 102 for detection purposes, for instance a RF beacon signal that conveys information about the access network 102, such as an identifier, supported communication protocols, etc. Alternatively, the access network 110 can communicate such information to the access terminal 106, for example if the access network 110 detects that the access terminal 106 is moving into a geographic area serviced by the access network 102.

In response to determining that handoff to the access network 102 is desired, the access terminal 106 can communicate a registration request, or other suitable message(s), to the access network 102 to request registration with the access network 102. A dynamic header selection application 120 instantiated on the access network 102 can detect the type of data flow to be used to communicate with the access terminal 106. The dynamic header selection application 120 can be executed by a controller 122 within the access network 102 to implement dynamic header selection, as well as perform the other methods and processes described herein. The controller 122 can comprise, for example, one or more processors within a network node. Examples of suitable network nodes include, but are not limited to, network servers, access points, base transceiver stations, base station controllers, and the like.

In one arrangement, the dynamic header selection application 120 can identify the type of header that is used by the access terminal 106 in the registration request. For example, if the header is a packet-based header, the dynamic header selection application 120 can determine that packet-based data flows are suitable for communicating with the access terminal 106. If, however, the header that is used by the access terminal 106 in the registration request is octet-based (e.g. using High-level Data Link Control (HDLC) frames with a fixed octet pattern), the dynamic header selection application 120 can determine that octet-based data flows are suitable for communicating with the access terminal 106.

In another arrangement, the detection of the type of data flow to be used to communicate with the access terminal 106 can be based on one or more attributes provided in one or more of the messages communicated from the access terminal 106 to the access network 102. Such attributes can be, for example, values that are assigned to identify suitable higher layer protocols. Examples of higher layer protocols can include, but are not limited to, robust header compression (ROHC) and Internet Protocol (IP) (e.g. IPv4 and IPv6). For instance, in the MFPA protocol, a value of 0x08 can be assigned to identify RoHC and a value of 0x09 can be assigned to identify IPv4 and/or IPv6. Still, other values can be assigned and the invention is not limited in this regard.

In one arrangement, one or more fields can be defined within a packet or frame header to convey the attributes that identify the type of data flow to be used. Alternatively, such fields can be defined within a footer or a body of a packet or frame, or defined in any other suitable manner. The attributes can be communicated from the access terminal 106 to the access network 102 in the defined fields, and identification of such attributes by the dynamic header selection application 120 can indicate to the access network 102 to communicate with the access terminal 106 using packet-based data flows. Absence of such an attribute, however, can indicate to the access network 102 to communicate with the access terminal 106 using octet-based data flows.

In another arrangement, fields also can be defined for attributes to identify when octet-based communications are preferred for communications with the access terminal 106. Again, the attributes can be communicated from the access terminal 106 to the access network 102 within a header, a footer or a body of a packet or frame, or communicated in any other suitable manner. Identification of such attributes by the dynamic header selection application 120 can indicate to the access network 102 to communicate with the access terminal 106 using octet-based data flows.

In response to detecting the type of data flow that is to be used to communicate with the access terminal 106, the dynamic header selection application 120 can dynamically select a suitable type of packet header that is to be used to communicate with the access terminal 106. For example, if the dynamic header selection application 120 detects that data flows communicated to the access terminal 106 are to be packet-based, the dynamic header selection application 120 can select a packet-based header 124 that tracks packet boundaries. In this regard, such packet header can eliminate the need for the data flow to include PPP overhead that otherwise may be required, for instance PPP header with corresponding PPP attributes. Packet based frames 126 then can be generated and communicated from the access network 102 to the access terminal 106 using the packet-based header type, which reduces inter-access network handoff implementation complexities without significantly tasking other resources of the communication system 100.

If, however, the dynamic header selection application 120 detects that octet-based data flows are suitable for communicating with the access terminal 106, the dynamic header selection application 120 can select an octet-based header 128, such as those known in the art, that supports octet-based data flow. The octet-based header 128 can include attributes that support PPP between the access network 102 and the access terminal 106, or separate PPP headers can be provided. Packet-based frames 126 then can be communicated from the access network 102 to the access terminal 106 using the octet-based header 128 for one or more packets. Notwithstanding, a packet-based header 124 still can be used for auxiliary signaling and content data flows on MFPA, thereby eliminating data dependent packet expansion that may otherwise occur due to escaped bits if octet-based framing were to be used on these signaling and content data flows.

In one arrangement, the packet headers 124, 128 that are selected can be packet headers that comply with radio link protocol (RLP). As known to the skilled artisan, RLP provides retransmission and duplicate detection for an octet-based data stream communicated using PPP. However, the arrangements described herein can be applied to RLP headers to support packet-based communications as well. As noted, this eliminates the need for the RLP data flow to include PPP overhead (e.g. headers/attributes) when the access network 102 communicates with a packet-based access terminal 106. In addition, the ability to selectively include PPP provides backward compatibility with legacy HDLC/octet-based access terminals, such as those that are configured to implement Voice over Internet Protocol (VoIP) in a Data Optimized Rev. A (DOrA) Service Option (SO) 64 based system (e.g. a system that implements the Third Generation Partnership Project 2 (3GPP2) C.S0024-A, C.R1001-F and X.S0011-004-D specifications, and the 3GPP2 Interoperability Specifications (IOS)).

In one arrangement, protocol indicators 130 can be provided by the access network 102 to the access terminal to indicate one or more higher layer protocols to be implemented in RLP data flows. For example, the access network 102 can identify to the access terminal 106 a type of higher layer protocol that is to be used for uplink communications from the access terminal 106 to the access network 102, a type of higher layer protocol that is to be used for downlink communications from the access network 102 to the access terminal 106, and a higher layer protocol to be used for auxiliary signaling and/or auxiliary content data flows. The protocol indicators can be generated by the dynamic header selection application 120.

Similarly, the access terminal 106 can provide protocol indicators 130 to the access network 102 to indicate what higher level protocols the access terminal 106 supports. The access network 102 can process such protocol indicators 130 when selecting the higher layer protocols to be implemented, if any. As noted, examples of higher layer protocols include, but are not limited to, ROHC and IP. The indicators can be provided in any other suitable manner, for example within the headers, footers or the bodies of frames or packets.

FIG. 2 depicts field definitions 200 for fields 202, 204, 206, 208 of an RLP header for packet-based framing in MFPA, which is useful for understanding the present invention. The RLP header may be dynamically selected by the dynamic header selection process 120 of the access network 102, and can be used by the access terminal 106 to communicate with the access network 102 using a packet-based data flow. The RLP header also can include any of a myriad of other fields (not shown). In one arrangement, the fields 202-208 also may be provided in an RLP header for octet-based framing, though this need not be the case.

Each of the fields 202-208 can be identified by field identifier 210 and have a suitable field length 212 (e.g. a bit length). A first field 202 can be identified as RLPID to indicate that the field contains an identifier for the corresponding RLP data flow. The length 212 of the field 202 can be any suitable number of bits that may be required to contain the identifier.

A second field 204 can be identified as SEQ to indicate that the field 204 corresponds to an RLP sequence number of a first data unit in the RLP payload to which the RLP header corresponds. If the RLP packet is being sent on a forward link, a length 212 of the field 204 can be indicated by a forward flow sequence length attribute corresponding to the data flow. If, however, the RLP packet is being sent on a reverse link, the length 212 of the field 204 can be indicated by a reverse flow sequence length corresponding to data flow.

A third field 206 can be identified as FirstDataUnit and have a length 212 of 1 bit. The field 206 can be set to “1” if the RLP data flow is carrying a packet data stream, and the payload of the RLP packet to which the RLP header corresponds is a first segment packet for the RLP data flow. If the payload is not a first segment packet, then the field 206 can be set to “0.” Further, the field 206 also can be set to “0” in the case that the RLP data flow is an octet data stream.

A fourth field 208 can be identified as LastDataUnit and also have a length 212 of 1 bit. The field 208 can be set to “1” if the RLP data flow is carrying a packet data stream, and the payload of this RLP packet to which the RLP header corresponds is a last segment packet of the RLP data flow. If the payload is not a last segment packet, then the field 208 can be set to “0.” Again, the field 208 also can be set to “0” in the case that the RLP data flow is an octet data stream. At this point it should be noted that a myriad of other fields can be provided in the RLP header and the invention is not limited in this regard.

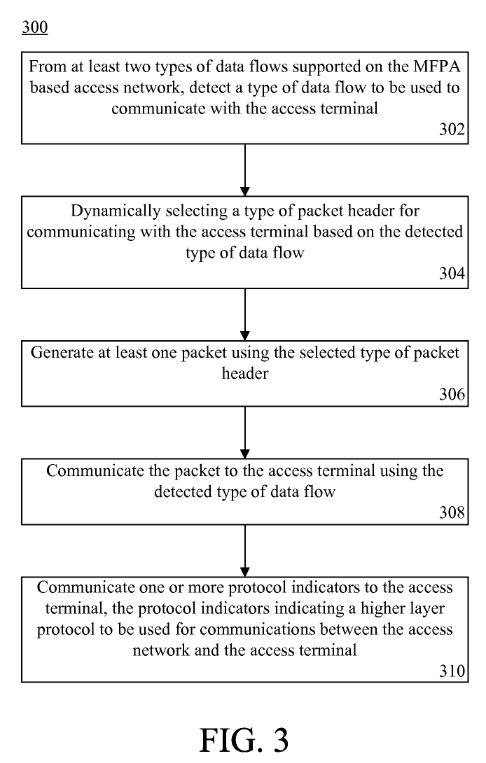

FIG. 3 is a flowchart that presents a method 300 which is useful for understanding the present invention. At step 302, from at least two types of data flows supported on the MFPA based access network, a type of data flow to be used to communicate with the access terminal can be detected. For example, an octet based data flow type or a packet-based data flow type can be detected.

At step 304, a type of packet header for communicating with the access terminal based on the detected type of data flow can be dynamically selected. For example, a packet-based header that complies with RLP can be selected. In one arrangement, the packet-based header can include at least a first field that identifies an RLP data flow to which the packet header corresponds and at least a second field that identifies an RLP sequence number of a first data unit in an RLP payload to which the packet header corresponds. The packet-based header also can include at least a third field that indicates whether the RLP payload corresponds to a first segment packet of the RLP data flow, and at least a fourth field that indicates whether the RLP payload corresponds to a last segment packet of the RLP data flow.

At step 306, at least one packet can be generated using the selected type of packet header. At step 308, the packet can be communicated to the access terminal using the detected type of data flow. In one arrangement, the packet-based data flow need not include PPP attributes.

At step 310, one or more protocol indicators can be communicated to the access terminal. The protocol indicators can indicate a higher layer protocol to be used for communications between the access network and the access terminal. For example, a first protocol indicator that is communicated to the access terminal can indicate a higher layer protocol to be used by the access network to communicate data to the access terminal. A second protocol indicator that is communicated to the access terminal can indicate a higher layer protocol to be used by the access terminal to communicate data to the access network. Further, a third protocol indicator that is communicated to the access terminal can indicate a higher layer protocol to be used for auxiliary signaling or auxiliary content data flows.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, parameter, attribute, signal, item, object, device, system, apparatus, step, process, or the like from another message, parameter, attribute, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of supporting communication between a Multi-flow Packet Application (MFPA) based access network and an access terminal, comprising:
from at least two types of data flows supported on the MFPA based access network, detecting a type of data flow to be used to communicate with the access terminal;
dynamically selecting a type of packet header for communicating with the access terminal based on the detected type of data flow;
generating at least one packet using the selected type of packet header; and
communicating the packet to the access terminal using the detected type of data flow.

2. The method of claim 1, wherein communicating the packet to the access terminal using the detected type of data flow comprises communicating a packet-based data flow that does not include point-to-point protocol attributes.

3. The method of claim 1, wherein:
detecting the type of data flow to be used to communicate with the access terminal comprises detecting a packet-based data flow; and
dynamically selecting the type of packet header comprises selecting a packet-based header that complies with radio link protocol (RLP).

4. The method of claim 3, wherein dynamically selecting the packet-based header comprises selecting a header that comprises:
at least a first field that identifies an RLP data flow to which the packet header corresponds;
at least a second field that identifies an RLP sequence number of a first data unit in an RLP payload to which the packet header corresponds;
at least a third field that indicates whether the RLP payload corresponds to a first segment packet of the RLP data flow; and
at least a fourth field that indicates whether the RLP payload corresponds to a last segment packet of the RLP data flow.

5. The method of claim 1, wherein detecting a type of data flow to be used to communicate with the access terminal comprises:
detecting at least one type of data flow selected from a group consisting of a packet-based data flow and an octet-based data flow.

6. The method of claim 1, further comprising:
communicating at least one protocol indicator to the access terminal, the protocol indicator indicating a higher layer protocol to be used for communications between the access network and the access terminal.

7. The method of claim 1, further comprising:
communicating a first protocol indicator to the access terminal, the first protocol indicator indicating a higher layer protocol to be used by the access network to communicate data to the access terminal; and
communicating a second protocol indicator to the access terminal, the second protocol indicator indicating a higher layer protocol to be used by the access terminal to communicate data to the access network.

8. The method of claim 7, further comprising:
communicating a third protocol indicator to the access terminal, the third protocol indicator indicating a higher layer protocol to be used for auxiliary signaling or auxiliary content data flows.

9. A Multi-flow Packet Application (MFPA) based access network, comprising:
a controller that:
from at least two types of data flows supported on the MFPA based access network, detects a type of data flow to be used to communicate with an access terminal;
dynamically selects a type of packet header for communicating with the access terminal based on the detected type of data flow;
generates at least one packet using the selected type of packet header; and
communicates the packet to the access terminal using the detected type of data flow.

10. The MFPA based access network of claim 9, wherein the detected type of data flow does not include point-to-point protocol attributes.

11. The MFPA based access network of claim 9, wherein:
the detected type of data flow is a packet-based data flow; and
the selected type of packet header is a packet-based header that complies with radio link protocol (RLP).

12. The MFPA based access network of claim 11, wherein the packet-based header comprises:
at least a first field that identifies an RLP data flow to which the packet header corresponds;
at least a second field that identifies an RLP sequence number of a first data unit in an RLP payload to which the packet header corresponds;
at least a third field that indicates whether the RLP payload corresponds to a first segment packet of the RLP data flow; and
at least a fourth field that indicates whether the RLP payload corresponds to a last segment packet of the RLP data flow.

13. The MFPA based access network of claim 9, wherein the type of data flow that is detected is a packet-based data flow or an octet-based data flow.

14. The MFPA based access network of claim 9, wherein the controller communicates at least one protocol indicator to the access terminal, the protocol indicator indicating a higher layer protocol to be used for communications between the access network and the access terminal.

15. The MFPA based access network of claim 9, wherein the controller communicates a first protocol indicator to the access terminal, the first protocol indicator indicating a higher layer protocol to be used by the access network to communicate data to the access terminal, and communicates a second protocol indicator to the access terminal, the second protocol indicator indicating a higher layer protocol to be used by the access terminal to communicate data to the access network.

16. The MFPA based access network of claim 15, wherein the controller communicates a third protocol indicator to the access terminal, the third protocol indicator indicating a higher layer protocol to be used for auxiliary signaling or auxiliary content data flows.

17. A computer program product comprising:
a computer-usable medium comprising computer-usable program code that supports communication between a Multi-flow Packet Application (MFPA) based access network and an access terminal, the computer-usable medium comprising:
computer-usable program code that from at least two types of data flows supported on the MFPA based access network, detects a type of data flow to be used to communicate with an access terminal;
computer-usable program code that dynamically selects a type of packet header for communicating with the access terminal based on the detected type of data flow;
computer-usable program code that generates at least one packet using the selected type of packet header; and
computer-usable program code that communicates the packet to the access terminal using the detected type of data flow.

18. The computer program product of claim 17, wherein the computer-usable program code that communicates the packet to the access terminal using the detected type of data flow comprises:
computer-usable program code that communicates a packet-based data flow that does not include point-to-point protocol attributes.

19. The computer program product of claim 17, wherein:
the computer-usable program code that detects the type of data flow to be used to communicate with an access terminal comprises:
computer-usable program code that detects a packet-based data flow; and
the computer-usable program code that dynamically selects the type of packet header for communicating with the access terminal comprises:
computer-usable program code that selects a packet-based header that complies with radio link protocol (RLP).

20. The computer program product of claim 19, wherein the computer-usable program code that dynamically selects the packet-based header comprises:
computer-usable program code that generates at least a first field in the packet-based header that identifies an RLP data flow to which the packet header corresponds;
computer-usable program code that generates at least a second field in the packet-based header that identifies an RLP sequence number of a first data unit in an RLP payload to which the packet header corresponds;
computer-usable program code that generates at least a third field in the packet-based header that indicates whether the RLP payload corresponds to a first segment packet of the RLP data flow; and
computer-usable program code that generates at least a fourth field in the packet-based header that indicates whether the RLP payload corresponds to a last segment packet of the RLP data flow.
